(19) United States
(12) Patent Application Publication
(10) Pub. No.: US 2017/0150475 A1
(43) Pub. Date: May 25, 2017

(54) POSITIONING METHOD AND APPARATUS AND COMMUNICATION SYSTEM

(71) Applicant: FUJITSU LIMITED, Kawasaki-shi (JP)

(72) Inventors: Hongchao LI, Beijing (CN); Hua ZHOU, Beijing (CN)

(73) Assignee: FUJITSU LIMITED, Kawasaki-shi (JP)

(21) Appl. No.: 15/425,226

(22) Filed: Feb. 6, 2017

Related U.S. Application Data
(63) Continuation of application No. PCT/CN2014/083782, filed on Aug. 6, 2014.

(51) Int. Cl. H04W 64/00; H04W 72/10; H04W 76/04

(52) U.S. Cl. CPC H04W 64/003; H04W 76/043; H04W 72/10

(57) ABSTRACT

Embodiments of this disclosure provide a positioning method and apparatus and communication system. The method includes: a first communication equipment transmits a triggering command to a second communication equipment, so as to trigger the second communication equipment to transmit a positioning signal; wherein, the first communication equipment or the second communication equipment is a node whose position is known; the first communication equipment detects and receives the positioning signal according to a configured resource used by the positioning signal; and the first communication equipment estimates a distance or signal propagation time from the first communication equipment to the second communication equipment according to the positioning signal. With the embodiments of this disclosure, positioning services may be provided for some UEs by using some low-power nodes (including UE or eNBs) whose accurate positions are known, thereby improving positioning precision.

### CROSS REFERENCE TO RELATED APPLICATIONS

This application is a continuation application of International Application PCT/CN2014/083782 filed on Aug. 6, 2014, the entire contents of which are incorporated herein by reference.

### TECHNICAL

The present disclosure relates to the field of communications, and in particular to a positioning method and apparatus and a communication system.

### BACKGROUND

A peer-to-peer (P2P) communication or a proximity service of device-to-device (D2D) is relatively direct exchange and communication mode between user equipment. If there exists no support from infrastructures at a network side, the D2D communication is similar to communication in an ad hoc network. And if there exists support from the infrastructures at the network side, such as integrating D2D into a cellular communication network, at least the following advantages and applications may be brought about:

D2D discovery may serve for applications of neighboring equipment, and such a feature of neighboring user equipment (UE) may serve for multiple commercial application aspects and common security fields;

D2D communication may serve for instant communication demands needed by common security fields, and may also provide services related to commercial demands in advance, such as social networks, and smart homes, etc.;

D2D communication may be used when neighboring UE has a demand for communication, and using such a communication scheme may increase a system throughput, lower power consumption of the UE, and perform traffic offloading at an eNodeB side; and

the technique of adopting D2D as relay may enhance a cell coverage.

And on the other hand, since Release-99 of the universal telecommunication radio access (UTRA) and Release-9 of evolved-UMTS (universal mobile telecommunication system) terrestrial radio access (E-UTRA), a positioning technique, as a key technique, has been standardized by the 3rd generation partnership project (3GPP), such as assisted-global navigation satellite system (A-GNSS), observed time difference of arrival (OTDOA), enhanced-cell identity (E-CID), and uplink time difference of arrival (UTDOA). Currently, the study of the enhanced 911 ability by the Federal Communications Commission is mainly directed to positioning within buildings.

At present, positioning of UE is a service provided by most operators, in which coordinate information of a certain precision is obtained by estimating a position of the UE by an eNB. However, due to being limited by some objective conditions, such as a signal bandwidth, a resolution, a synchronization error between coordinated eNBs, and a channel condition, etc., a positioning precision is limited if an eNB is singly used; and in some application scenarios, positioning performances are not satisfied, such as in an indoor application scenario.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

Embodiments of the present disclosure provide a positioning method and apparatus and a communication system, so as to improve a positioning precision.

According to a first aspect of the embodiments of the present disclosure, there is provided a positioning method, wherein the method includes: a first communication equipment transmits a triggering command to a second communication equipment, so as to trigger the second communication equipment to transmit a positioning signal; wherein, the first communication equipment or the second communication equipment is a node whose position is known; the first communication equipment detects and receives the positioning signal according to a configured resource used by the positioning signal; and the first communication equipment estimates a distance or signal propagation time from the first communication equipment to the second communication equipment according to the positioning signal.

According to a second aspect of the embodiments of the present disclosure, there is provided a positioning method, wherein the method includes: a second communication equipment receives a triggering command transmitted by a first communication equipment; and the second communication equipment transmits a positioning signal on a configured resource used by a positioning signal according to the triggering command, so that the first communication equipment estimates a distance or signal propagation time from the first communication equipment to the second communication equipment according to the positioning signal.

According to a third aspect of the embodiments of the present disclosure, there is provided a positioning method, wherein the method includes: a positioning request transmitted by a first communication equipment or a second communication equipment is received; a resource used by a positioning signal is configured according to the positioning request; and the resource used by the positioning signal is transmitted via configuration information.

According to a fourth aspect of the embodiments of the present disclosure, there is provided a positioning apparatus, applicable to a first communication equipment, wherein the apparatus includes: a triggering unit configured to transmit a triggering command to a second communication equipment, so as to trigger the second communication equipment to transmit a positioning signal; wherein, the first communication equipment or the second communication equipment is a node whose position is known; a detecting unit configured to detect and receive the positioning signal according to a configured resource used by the positioning signal; and an estimating unit configured to estimate a distance or signal propagation time from the first communication equipment to the second communication equipment according to the positioning signal.

According to a fifth aspect of the embodiments of the present disclosure, there is provided a positioning apparatus, applicable to a second communication equipment, wherein the apparatus includes: a first receiving unit configured to receive a triggering command transmitted by a first communication equipment; and a first transmitting unit configured to transmit a positioning signal on a configured resource used by a positioning signal according to the triggering command, so that the first communication equipment estimates a distance or signal propagation time from the first communication equipment to the second communication equipment according to the positioning signal.

According to a sixth aspect of the embodiments of the present disclosure, there is provided a positioning apparatus, including: a first receiving unit configured to receive a positioning request transmitted by a first communication equipment or a second communication equipment; a configuring unit configured to configure a resource used by a positioning signal according to the positioning request; and a transmitting unit configured to transmit the resource used by the positioning signal via configuration information.

According to a seventh aspect of the embodiments of the present disclosure, there is provided a communication equipment, including the positioning apparatus as described in the fourth or the fifth or the sixth aspect.

According to an eighth aspect of the embodiments of the present disclosure, there is provided a communication system, including a first communication equipment and a second communication equipment, and alternatively, including a third communication equipment; wherein, the first communication equipment may include the positioning apparatus as described in the fourth aspect, the second communication equipment may include the positioning apparatus as described in the fifth aspect, and the third communication equipment may include the positioning apparatus as described in the sixth aspect.

An advantage of the embodiments of the present disclosure exists in that with the method, apparatus and system of the embodiments of the present disclosure, a positioning precision is improved.

With reference to the following description and drawings, the particular embodiments of the present disclosure are disclosed in detail, and the principles of the present disclosure and the manners of use are indicated. It should be understood that the scope of the embodiments of the present disclosure is not limited thereto. The embodiments of the present disclosure contain many alternations, modifications and equivalents within scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the exemplary embodiments of the present disclosure, and are used for setting forth the principles of the present disclosure together with the description. It is clear and understood that the accompanying drawings in the following description are some embodiments of the present disclosure, and for those of ordinary skills in the art, other accompanying drawings may be obtained according to these accompanying drawings without making an inventive effort. In the drawings:

FIG. 1 is a flowchart of an implementation of the positioning method of an embodiment of the present disclosure;

FIG. 2 is a flowchart of another implementation of the positioning method of the embodiment of the present disclosure;

FIG. 3 is a flowchart of a further implementation of the positioning method of the embodiment of the present disclosure;

FIG. 4 is a schematic diagram of a positioning scenario of an embodiment of the present disclosure;

FIG. 5 is a schematic diagram of another positioning scenario of the embodiment of the present disclosure;

FIG. 6 is a schematic diagram of an implementation of a structure of the positioning apparatus of an embodiment of the present disclosure;

FIG. 7 is a schematic diagram of another implementation of a structure of the positioning apparatus of the embodiment of the present disclosure;

FIG. 8 is a schematic diagram of a further implementation of a structure of the positioning apparatus of the embodiment of the present disclosure;

FIG. 9 is a schematic diagram of an implementation of a structure of the communication equipment of an embodiment of the present disclosure;

FIG. 10 is a schematic diagram of another implementation of a structure of the communication equipment of the embodiment of the present disclosure; and

FIG. 11 is a schematic diagram of a structure of the communication system of an embodiment of the present disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

The embodiments of this disclosure provide a positioning method and apparatus and a communication system, with an aim being to provide positioning services to some UE by using some low-power nodes (including UE or eNBs) whose accurate positions are known. The method, apparatus and system of the embodiment shall be described below in detail with reference to the accompanying drawings.

### Embodiment 1

An embodiment of the present disclosure provides a positioning method. FIG. 1 is a flowchart of the method. Referring to FIG. 1, the method includes:

step 101: a first communication equipment transmits a triggering command to a second communication equipment, so as to trigger the second communication equipment to transmit a positioning signal; wherein, the first communication equipment or the second communication equipment is a node whose position is known;

step 102: the first communication equipment detects and receives the positioning signal according to a configured resource used by the positioning signal; and

step 103: the first communication equipment estimates a distance or signal propagation time from the first communication equipment to the second communication equipment according to the positioning signal.

In an implementation, the first communication equipment is a node whose position is known, the second communication equipment is a node to be positioned. The first communication equipment determines the distance or the signal propagation time (also referred to as round-trip time) from itself to the second communication equipment according to the method of this embodiment, thereby determining the position of the second communication equipment. In another implementation, the first communication equipment is a node to be positioned, the second communication equipment is a node whose position is known. The first communication equipment determines the distance or the signal propagation time from itself to the second communication equipment by using the positioning signal provided by the second communication equipment according to the method of this embodiment, thereby determining the position of itself.

In step 101, the triggering command may be indication information indicating a positioning ability of the first communication equipment, such as an ability to measure round-trip time, or an ability to measure a distance, etc., and this embodiment is not limited thereto. And the triggering command may be transmitted via a synchronization channel, a data channel, a control channel, or a synchronization signal, of D2D communication; however, this embodiment is not limited thereto. In this embodiment, the second communication equipment may transmit the positioning signal in the resource used by the positioning signal according to the received triggering command. The resource used by the positioning signal shall be described later.

In step 102, the first communication equipment may request the second communication equipment or a third communication equipment for configuring it with a resource used by the positioning signal by transmitting a positioning request to the second communication equipment or the third communication equipment, may also obtain a resource used by the positioning signal by configuring the second communication equipment with the resource used by the positioning signal, or may also obtain a resource used by the positioning signal by receiving a broadcast signal, and details shall be described later.

In an implementation of this embodiment, when the first communication equipment is a node to be positioned and the second communication equipment is a node whose position is known, the first communication equipment may transmit a positioning request to the second communication equipment or other communication equipment (referred to as a third communication equipment in this embodiment), requesting the second communication equipment or the third communication equipment for configuring it with a resource used in transmitting or receiving a positioning signal. After receiving the positioning request, the second communication equipment or the third communication equipment may configure a resource used by the positioning signal for the first communication equipment or other communication equipment having a demand for positioning according to resource usage and/or other policies.

In this implementation, after configuring the resource used by the positioning signal, the second communication equipment or the third communication equipment will transmit configuration information, issuing the resource used by the positioning signal. And the first communication equipment may further receive the configuration information transmitted by the second communication equipment or the third communication equipment, the configuration information containing the resource used by the positioning signal configured by the second communication equipment or the third communication equipment.

In this implementation, the second communication equipment and the third communication equipment may be UE whose accurate positions are known, and may also be eNBs whose accurate positions are known, and this embodiment is not limited thereto. In this implementation, a configuration method is similar to a method for configuring a resource used by the positioning signal by the first communication equipment described below, and shall be described later.

In another implementation of this embodiment, when the first communication equipment is a node whose position is known and the second communication equipment is a node to be positioned, as described above, the second communication equipment, which is a node to be positioned, may possibly transmit a positioning request to the first communication equipment, which is a node whose position is known, and the first communication equipment may further receive the positioning request transmitted by the second communication equipment, configure the resource used by the positioning signal according to the positioning request, and transmit the resource used by the positioning signal configured by it via the configuration information.

In this implementation, the first communication equipment may be UE whose accurate position is known, and may also be an eNB whose accurate position is known.

In this implementation, the first communication equipment may configure the resource used by the positioning signal via a synchronization channel and/or a control channel and/or a data channel (including scheduling assignment), of D2D communication, and may also configure the resource used by the positioning signal via system information or specific signaling of a cellular network; however, this embodiment is not limited thereto.

When the first communication equipment configures the resource used by the positioning signal via the system information of the cellular network, it transmits configuration information by broadcast, directed to nodes within its coverage range participating in a positioning function and process, including nodes whose positions are known and nodes whose positions are unknown, such as the above-described second communication equipment and third communication equipment, and possibly further including other communication equipment. And nodes receiving the configuration information may accordingly determine respective resources in receiving and transmitting positioning signals, that is, time, frequency and sequences used for transmitting or receiving the positioning signals.

When the first communication equipment configures the resource used by the positioning signal via the specific signaling of the cellular network or a synchronization channel and/or a control channel and/or a data channel, of D2D communication, it is directed to a node transmitting a positioning request, such as the above-described second communication equipment, and a node receiving the configuration information may accordingly determine a resource in receiving and transmitting a positioning signal, that is, time, frequency and a sequence used for transmitting or receiving the positioning signal.

In this embodiment, the resource used by the positioning signal, as described above, may include a bandwidth, a frequency domain position, a time domain position, a symbol length, and a sequence length, etc., and alternatively, the resource used by the positioning signal may also be signatures indicating a time-frequency resource index and a sequence index.

For example, the configuration information is “distance measurement format #0”, which indicates a bandwidth of 10 MHz, a symbol length of 3 (three SC-FDMA symbols or OFDM symbols), and some sequences of certain lengths. The sequence here may be Zadoff-Chu sequence, however, it is not limited thereto. Such configuration is applicable to a scenario of long-distance positioning having a requirement on transmission and detection distances.

For another example, the configuration information is “distance measurement format #1”, which indicates a bandwidth of 20 MHz, a symbol length of 2 (two SC-FDMA symbols or OFDM symbols), and some sequences of certain lengths. The sequence here may be Zadoff-Chu sequence, however, it is not limited thereto. Such configuration is applicable to a scenario of relatively short distance positioning having a relatively low requirement on transmission and detection distances and a relatively high requirement on precision and resolution.

In this embodiment, alternatively, the configuration information may be indicated by the above-described signatures. The signatures indicates a time-frequency source index and a sequence index, thereby uniquely determining one UE, that is, different UEs are orthogonal to each other via the signatures, so as to reduce interference therebetween.

In this embodiment, for the scenario having a relatively high requirement on resolution and precision, the first communication equipment may configure a resource used by the positioning signal of a high bandwidth, such as using a bandwidth of 10 MHz or even 20 MHz, and the UEs may be differentiated by multiplexing method(s) of TDM and/or CDM.

In this embodiment, the positioning signal may be a reference symbol or sequence for positioning or ranging, etc., such as a distance measurement signal, a distance measurement sequence, or a positioning preamble, etc. The positioning signal may be introduced into an existing D2D communication system, or may be an existing D2D signal, such as a synchronization signal. Positioning signals between different UEs may be code division multiplexing, time division multiplexing, or frequency division multiplexing. And a symbol length of the positioning signal may be determined by a positioning ranging distance expected to be supported, or may further be determined by other factors. For example, in a D2D application scenario, if a range of a positioning ranging distance expected to be supported is 5 kilometers, in order to avoid occurrence of unclearness of distance estimation, the signal length needs to satisfy:

Tseq>=5*2*10³/(3*10⁸)+16.67*10⁻⁶=50.005 us.

Considering a requirement for satisfying relatively low probability of miss detection and probability of wrong detection, a sequence length may be 60˜80 us. While in order to resist multipath delay and set a sufficient guard time (GT) duration, absorb a maximum round-trip delay and delay spread, total time of a cyclic prefix (CP) plus the GT needs to be about 2*(10000/(3*10⁸))+16.67*10⁻⁶=83.34 us. Hence, the sequence itself needs to at least occupy one SC-FDMA or OFDM symbol, and together with the lengths of the CP and the GT, about two SC-FDMA or OFDM symbols are totally needed.

In a further implementation of this embodiment, the first communication equipment receives the configuration information transmitted by the second communication equipment or the third communication equipment, the configuration information includes the resource used by the positioning signal configured by the second communication equipment or the third communication equipment.

In this implementation, as described above, the resource used by the positioning signal may possibly be configured via broadcast signaling, that is, it is transmitted by broadcast, and the first communication equipment of this embodiment neither needs to obtain the resource used by the positioning signal by transmitting a positioning request, nor needs to configure the resource used by the positioning signal by receiving a positioning request transmitted by other communication equipment, but directly receives the resource used by the positioning signal configured via broadcast signaling.

In this embodiment, the first communication equipment may further transmit indication information indicating a positioning ability of the first communication equipment to the second communication equipment or the third communication equipment, such as whether having an ability to measure round-trip time and/or whether having an ability to measure a distance, etc., so as to assist the second communication equipment or the third communication equipment in allocating resources and applying a positioning function. In an implementation, as described above, the above indication information may be taken as the above-described triggering command to trigger the second communication equipment to transmit the positioning signal.

In this embodiment, the above-described positioning request, configuration information, triggering command and indication information may be carried by a physical device-to-device synchronization channel (PD2DSCH), and may also be carried by a discovery message, and this embodiment is not limited thereto.

In step 103, the first communication equipment may estimate the distance or the signal propagation time from the first communication equipment to the second communication equipment according to the received positioning signal. In this embodiment, the number of the second communication equipment may be one or multiple, depending on an actual situation. For example, when the second communication equipment is a node whose position is known, the number of the second communication equipment may be multiple, and the first communication equipment estimates the distance or the signal propagation time from the first communication equipment to the second communication equipment according to multiple results (positioning signals) reported by the multiple second communication equipment. For another example, when the second communication equipment is a node to be positioned, the number of the second communication equipment may be one, and the first communication equipment estimates the distance or the signal propagation time from the first communication equipment to the second communication equipment according to the positioning signal reported by the second communication equipment.

In this embodiment, the first communication equipment may calculate a position of a node to be positioned (the first communication equipment or the second communication equipment) according to the estimated distance or signal propagation time, and may transmit the estimated distance or signal propagation time to a central fusion node, such as a terminal or an eNB, such that the central fusion node may calculate a position of a node to be positioned (the first communication equipment or the second communication equipment).

With the method of this embodiment, positioning services may be provided for some UEs by using some low-power nodes (including UE or eNBs) whose accurate positions are known, thereby improving positioning precision.

### Embodiment 2

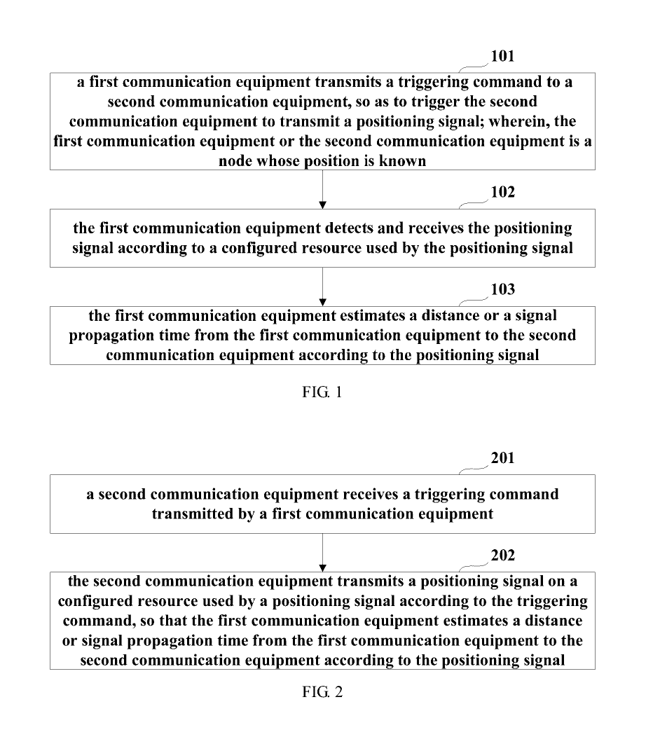

An embodiment of the present disclosure further provides a positioning method, which is processing at a second communication equipment side corresponding to the method of Embodiment 1, with contents identical to those in Embodiment 1 being not going to be described herein any further. FIG. 2 is a flowchart of the method. Referring to FIG. 2, the method includes:

step 201: a second communication equipment receives a triggering command transmitted by a first communication equipment; and

step 202: the second communication equipment transmits a positioning signal on a configured resource used by a positioning signal according to the triggering command, so that the first communication equipment estimates a distance or signal propagation time from the first communication equipment to the second communication equipment according to the positioning signal.

In step 201, as described in Embodiment 1, the triggering command may be indication information indicating a positioning ability of the first communication equipment, such as an ability to measure round-trip time, or an ability to measure a distance, etc. And the second communication equipment may be a node whose position is known, such as UE or an eNB, etc., and the second communication equipment may also be a node to be positioned, such as UE or an eNB, etc.

In step 202, the second communication equipment may transmit the positioning signal on the configured resource used by the positioning signal according to the triggering command.

In this embodiment, the second communication equipment may transmit the positioning signal by following timing of a synchronization source or using timing of TA=0; however, this embodiment is not limited thereto.

In this embodiment, as described in Embodiment 1, the second communication equipment may request the first communication equipment or the third communication equipment to configure it with a resource used by the positioning signal by transmitting a positioning request to the first communication equipment or the third communication equipment, may also obtain a resource used by the positioning signal by configuring the first communication equipment with the resource used by the positioning signal, or may also obtain a resource used by the positioning signal by receiving configuration information transmitted by the first communication equipment or the third communication equipment by broadcast, details being similar to those in Embodiment 1, and being not going to be described herein any further.

In this embodiment, as described in Embodiment 1, the resource used by the positioning signal may include a bandwidth, a frequency domain position, a time domain position, a symbol length, and a sequence length, etc., and the resource used by the positioning signal may also be signatures indicating a time-frequency resource index and a sequence index, etc.

With the method of this embodiment, positioning services may be provided for some UEs by using some low-power nodes (including UE or eNBs) whose accurate positions are known, thereby improving positioning precision.

### Embodiment 3

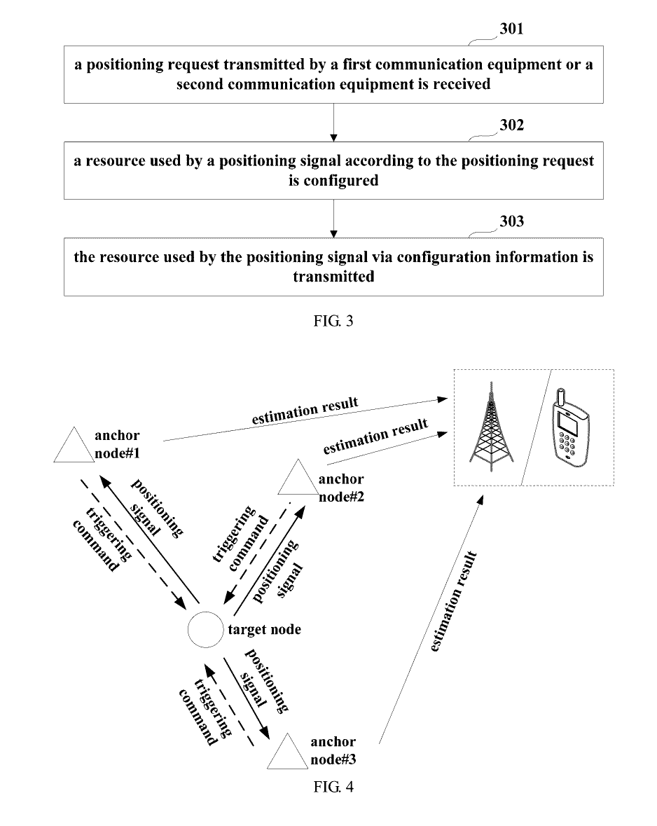

An embodiment of the present disclosure further provides a positioning method, which is processing at a third communication equipment side corresponding to the methods of embodiments 1 and 2, with contents identical to those in embodiments 1 and 2 being not going to be described herein any further. FIG. 3 is a flowchart of the method. Referring to FIG. 3, the method includes:

step 301: a positioning request transmitted by a first communication equipment or a second communication equipment is received;

step 302: a resource used by a positioning signal is configured according to the positioning request; and

step 303: the resource used by the positioning signal is transmitted via configuration information.

In this embodiment, the third communication equipment may be an eNB of a cellular network, and may also be a node in D2D communication with the first communication equipment or the second communication equipment. The third communication equipment may receive the positioning request transmitted by the first communication equipment or the second communication equipment, and configure the resource used by the positioning signal according to the positioning request. The method for configuring the resource used by the positioning signal has been described in Embodiment 1 in detail, the contents of which being incorporated herein, and being not going to be described herein any further.

In this embodiment, the third communication equipment may further receive a distance between the first communication equipment and the second communication equipment or a signal propagation time from the first communication equipment to the second communication equipment, and calculate a position of a node to be positioned (the first communication equipment or the second communication equipment) according to the distance or the signal propagation time.

In this embodiment, the third communication equipment may further receive a position of the first communication equipment or the second communication transmitted by the first communication equipment or the second communication equipment, so as to learn positions of each equipment.

In this embodiment, the resource used by the positioning signal may contain a bandwidth, a frequency domain position, a time domain position, a symbol length, and a sequence length, or the resource used by a positioning signal may be signatures indicating a time-frequency resource index and a sequence index, and Embodiment 1 may be referred to for details.

With the method of this embodiment, positioning services may be provided for some UEs by using some low-power nodes (including UE or eNBs) whose accurate positions are known, thereby improving positioning precision.

For the methods of embodiments 1-3 of this disclosure to be more clear and easy to be understood, the above methods of the embodiments shall be described below with reference to particular scenarios.

FIG. 4 is a schematic diagram of a positioning process of an implementation of the embodiment of the present disclosure. As shown in FIG. 4, in this implementation, the first communication equipment is a node whose position is known, marked as an anchor node #1, an anchor node #2, and an anchor node #3, the second communication equipment is a node to be positioned, marked as a target node, and the central fusion node is an eNB or central UE.

In this implementation, the anchor nodes #1-3 are nodes whose positions (accurate coordinates) are known), and the target node is a node to be positioned. The anchor nodes #1-3 provide synchronization references for the target node and trigger the target node to transmit positioning signals; the multiple anchor nodes receive the positioning signals and then estimate round-trip time, so as to estimate distances, and thereafter, they may perform data fusion processing by themselves, so as to obtain accurate coordinates of the target node; and estimation results may be reported to the central fusion node, such that the central fusion node may perform accurate position estimation.

In this implementation, the resource used by a positioning signal may be obtained by transmitting the positioning request by the target node to the anchor nodes #1-3 or the eNB/central UE, and configuring the resource by the anchor nodes #1-3 or the eNB/central UE for the target node. If the resource is configured by the anchor nodes #1-3, the anchor nodes #1-3 may configure the resource via a synchronization channel/a control channel/a data channel of D2D communication, and the anchor nodes #1-3 and the target node may determine the resource accordingly; and if the resource is configured by the eNB/central UE, the eNB/central UE may possibly configure the resource via system information, and may also configure the resource via specific signaling. If the resource is configured via system information, the anchor nodes #1-3 and the target node may obtain the resource by receiving broadcasted system information; and if the resource is configured via specific signaling, the eNB/central UE may, in addition to transmit the configured resource via the specific signaling to the target node transmitting the positioning request, transmit the configured resource via the specific signaling to nodes whose positions are known, such as the anchor nodes #1-3, hence, the anchor nodes #1-3 and the target node may obtain the configured resource via the specific signaling.

In this implementation, the triggering command triggering the target node to transmit the positioning signal may be transmitted via a synchronization channel, a data channel, a control channel, or a synchronization signal, of D2D communication, may be an ability indication field, and may also be other fields.

In this implementation, the resource used by the positioning signal and configuration and a definition of the positioning signal have been described in Embodiment 1 in detail, which shall not be described herein any further.

FIG. 5 is a schematic diagram of another implementation of a positioning process of the embodiment of the present disclosure. As shown in FIG. 5, in this implementation, the first communication equipment is a node to be positioned, marked as a target node, the second communication equipment is a node whose position is known, marked as an anchor node #1, an anchor node #2, and an anchor node #3, and the central fusion node is an eNB or central UE.

As shown in FIG. 5, the anchor nodes are nodes whose positions (accurate coordinates) are known, and the target node is a node to be positioned. The target node provides synchronization references for the anchor nodes and triggers the anchor nodes to transmit positioning signals. The target node receives the positioning signals transmitted by multiple anchor nodes, and then estimates round-trip time, so as to estimate distances; thereafter, it may perform data fusion processing by itself, so as to obtain accurate coordinates of the target node; and an estimation result may be reported to the central fusion node, such that the central fusion node may perform accurate position estimation.

In this embodiment, the resource used by the positioning signal and configuration and a definition of the positioning signal have been described in Embodiment 1 in detail, which shall not be described herein any further.

### Embodiment 4

An embodiment of the present disclosure provides a positioning apparatus, applicable to a communication equipment, which is referred to as a first communication equipment in this embodiment. The first communication equipment may be an eNB or UE, and may be a node whose position is known, or may be a node to be positioned. As principles of the positioning apparatus for solving problems are similar to that of the method in Embodiment 1, the implementation of the method in Embodiment 1 may be referred to for implementation of the apparatus, with identical contents being not going to be described herein any further.

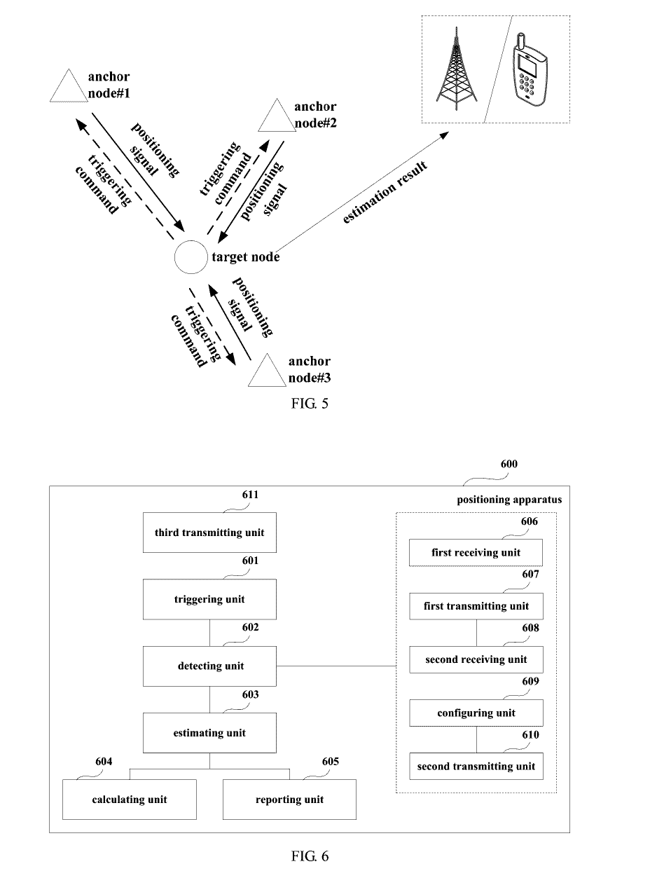

FIG. 6 is a schematic diagram of a structure of the positioning apparatus. As shown in FIG. 6, the positioning apparatus 600 includes: a triggering unit 601, a detecting unit 602 and an estimating unit 603.

In this embodiment, the triggering unit 601 is configured to transmit a triggering command to a second communication equipment, so as to trigger the second communication equipment to transmit a positioning signal; wherein, if the first communication equipment is a node whose position is known, the second communication equipment is a node to be positioned, and if the first communication equipment is a node to be positioned, the second communication equipment is a node whose position is known; wherein, the triggering command may be indication information indicating a positioning ability of the first communication equipment, and the triggering command may be transmitted via a synchronization channel, a control channel, a data channel, or a synchronization signal, of D2D communication.

In this embodiment, the detecting unit 602 is configured to detect and receive the positioning signal according to a configured resource used by the positioning signal. In this embodiment, the second communication equipment will transmit the positioning signal on the configured resource used by the positioning signal, and the detecting unit 602 may detect and receive the positioning signal on the configured resource used by the positioning signal. In this embodiment, the resource used by the positioning signal may include a bandwidth, a frequency domain position, a time domain position, a symbol length, and a sequence length, and may also be signatures indicating a time-frequency resource index and a sequence index.

In this embodiment, the estimating unit 603 is configured to estimate a distance or signal propagation time from the first communication equipment to the second communication equipment according to the positioning signal. In this embodiment, after receiving the positioning signal, the estimating unit 603 may estimate the distance or the signal propagation time from the first communication equipment to the second communication equipment; wherein, the prior art may be referred to for a estimation method, which shall not be described herein any further.

In an implementation of this embodiment, the apparatus may further include a calculating unit 604, which is configured to calculate a position of the first communication equipment or the second communication equipment according to the distance or the signal propagation time estimated by the estimating unit 603.

In another implementation of this embodiment, the apparatus may further include a reporting unit 605, which is configured to transmit the distance or the signal propagation time estimated by the estimating unit 603 to a central fusion node, such that the central fusion node may calculate the position of the first communication equipment or the second communication equipment.

In an implementation of this embodiment, the apparatus may further include a first receiving unit 606, which is configured to receive configuration information transmitted by the second communication equipment or a third communication equipment, the configuration information including a resource used by the positioning signal configured by the second communication equipment or the third communication equipment.

In an implementation of this embodiment, the apparatus may further include a first transmitting unit 607 and a second receiving unit 608. In this implementation, if the first communication equipment is a node to be positioned and the second communication equipment is a node whose position is known, the first transmitting unit 607 is configured to transmit a positioning request to the second communication equipment or the third communication equipment, and the second receiving unit 608 is configured to receive the configuration information transmitted by the second communication equipment or the third communication equipment, the configuration information including a resource used by the positioning signal configured by the second communication equipment or the third communication equipment.

In an implementation of this embodiment, the apparatus may further include a configuring unit 609 and a second transmitting unit 610. In this implementation, if the first communication equipment is a node whose position is known and the second communication equipment is a node to be positioned, the configuring unit 609 is configured to receive a positioning request transmitted by the second communication equipment and configure a resource used by the positioning signal according to the positioning request, and the second transmitting unit 610 is configured to transmit the configured resource used by the positioning signal via configuration information.

In an implementation of this embodiment, the apparatus may further include a third transmitting unit 611, which may transmit indication information indicating a positioning capability of the first communication equipment to the second communication equipment or the third communication equipment.

With the apparatus of this embodiment, positioning services may be provided for some UEs by using some low-power nodes (including UE or eNBs) whose accurate positions are known, thereby improving positioning precision.

### Embodiment 5

An embodiment of the present disclosure provides a positioning apparatus, applicable to a communication equipment, which is referred to as a second communication equipment in this embodiment. The second communication equipment may be an eNB or UE. As principles of the positioning apparatus for solving problems are similar to that of the method in Embodiment 2, the implementation of the method in Embodiment 2 may be referred to for implementation of the apparatus, with identical contents being not going to be described herein any further.

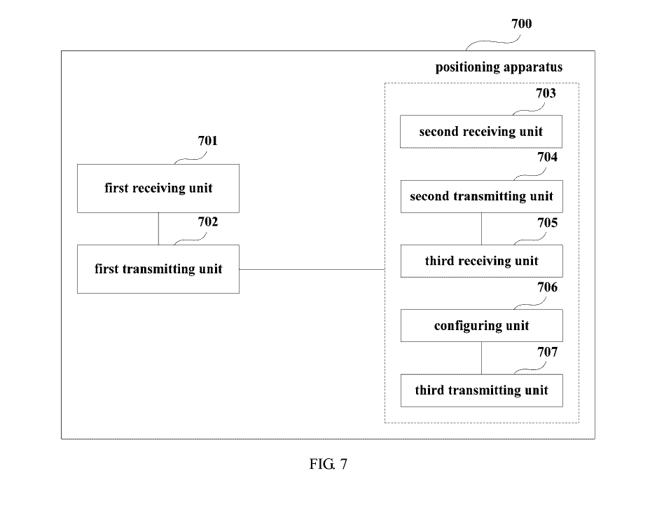

FIG. 7 is a schematic diagram of a structure of the positioning apparatus. As shown in FIG. 7, the apparatus 700 includes: a first receiving unit 701 and a first transmitting unit; wherein,

the first receiving unit 701 is configured to receive a triggering command transmitted by a first communication equipment; wherein, as described above, the triggering command may be indication information indicating a positioning ability of the first communication equipment, and may be transmitted via a synchronization channel, a data channel, a control channel, or a synchronization signal, of D2D communication;

and the first transmitting unit 702 is configured to transmit a positioning signal on a configured resource used by the positioning signal according to the triggering command received by the first receiving unit 701, so that the first communication equipment estimates a distance or signal propagation time from the first communication equipment to the second communication equipment according to the positioning signal; wherein the first transmitting unit 702 may transmit the positioning signal by following timing of a synchronization source or using timing of TA=0.

In an implementation of this embodiment, the apparatus may further include a second receiving unit 703, which is configured to receive configuration information transmitted by the first communication equipment or a third communication equipment, the configuration information including a resource used by the positioning signal configured by the first communication equipment or the third communication equipment.

In another implementation of this embodiment, the apparatus may further include a second transmitting unit 704 and a third receiving unit 705. In this implementation, the second transmitting unit 704 is configured to transmit a positioning request to the first communication equipment or the third communication equipment when the first communication equipment is a node whose position is known and the second communication equipment is a node to be positioned, and the third receiving unit 705 is configured to receive configuration information transmitted by the first communication equipment or the third communication equipment, the configuration information including a resource used by the positioning signal configured by the first communication equipment or the third communication equipment.

In a further implementation of this embodiment, the apparatus may further include a configuring unit 706 and a third transmitting unit 707. In this implementation, the configuring unit 706 is configured to receive a positioning request transmitted by the first communication equipment when the first communication equipment is a node to be positioned and the second communication equipment is a node whose position is known, and configure a resource used by the positioning signal according to the positioning request, and the third transmitting unit 707 is configured to transmit the resource used by the positioning signal configured by the configuring unit 706 via configuration information.

In this embodiment, the method for configuring the resource used by the positioning signal has been described in Embodiment 1 in detail, which shall not be described herein any further.

With the apparatus of this embodiment, positioning services may be provided for some UEs by using some low-power nodes (including UE or eNBs) whose accurate positions are known, thereby improving positioning precision.

### Embodiment 6

An embodiment of the present disclosure provides a positioning apparatus, applicable to a communication equipment, which is referred to as a third communication equipment in this embodiment. The third communication equipment may be an eNB or UE. As principles of the positioning apparatus for solving problems are similar to that of the method in Embodiment 3, the implementation of the method in Embodiment 3 may be referred to for implementation of the apparatus, with identical contents being not going to be described herein any further.

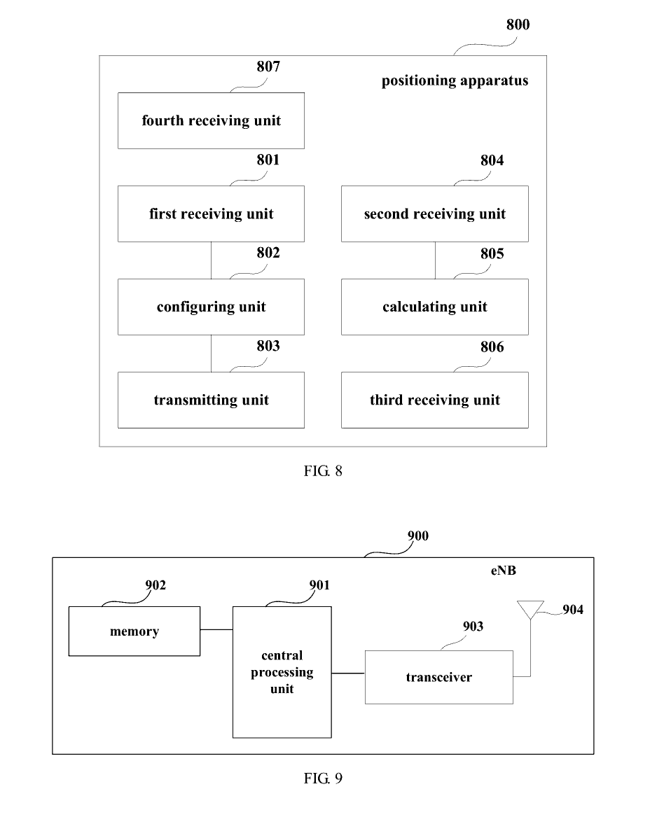

FIG. 8 is a schematic diagram of a structure of the positioning apparatus. As shown in FIG. 8, the apparatus 800 includes: a first receiving unit 801, a configuring unit 802 and a transmitting unit 803; wherein,

the first receiving unit 801 is configured to receive a positioning request transmitted by a first communication equipment or a second communication equipment;

the configuring unit 802 is configured to configure a resource used by a positioning signal according to the positioning request;

and the transmitting unit 803 is configured to transmit the resource used by the positioning signal via configuration information.

In an implementation of this embodiment, the apparatus may further include a second receiving unit 804 and a calculating unit 805. In this implementation, the second receiving unit 804 is configured to receive a distance or signal propagation time from the first communication equipment to the second communication equipment, which may be transmitted by the first communication equipment, or may be transmitted by the second communication equipment, and the calculating unit 805 is configured to calculate a position of a node to be positioned (the first communication equipment or the second communication equipment) according to the distance or the signal propagation time.

In an implementation of this embodiment, the apparatus may further include a third receiving unit 806, which is configured to receive a position of a node to be positioned (the first communication equipment or the second communication equipment) transmitted by the first communication equipment or the second communication equipment.

In an implementation of this embodiment, the apparatus may further include a fourth receiving unit 807, which is configured to receive an ability indication field transmitted by the first communication equipment or the second communication equipment, so that the configuring unit 802 configures the above resource with reference to an ability indicated by the ability indication field, or performs positioning with reference to an ability indicated by the ability indication field.

In this embodiment, the method for configuring the resource used by the positioning signal has been described in Embodiment 1 in detail, which shall not be described herein any further.

With the apparatus of this embodiment, positioning services may be provided for some UEs by using some low-power nodes (including UE or eNBs) whose accurate positions are known, thereby improving positioning precision.

### Embodiment 7

An embodiment of the present disclosure provides a communication equipment, which includes the positioning apparatus as described in Embodiment 4 or 5 or 6.

In this embodiment, the communication equipment may be an eNB, and may also be UE, which shall be described below respectively.

FIG. 9 is a schematic diagram of a structure of an eNB of the embodiment of the present disclosure. As shown in FIG. 9, the eNB 900 may include a central processing unit (CPU) 901 and a memory 902, the memory 902 being coupled to the central processing unit 901. In this embodiment, the memory 902 may store various data, and furthermore, it may store a program for information processing, and execute the program under control of the central processing unit 901, so as to receive various information transmitted by UE, and transmit various information to the UE.

In an implementation, the functions of the positioning apparatus may be integrated into the central processing unit 901, and the central processing unit 901 carries out the functions of the positioning apparatus as described in Embodiment 4 or 5 or 6. In this embodiment, the functions of the positioning apparatus are incorporated herein, and shall not be described herein any further.

In another implementation, the positioning apparatus and the central processing unit 901 may be configured separately. For example, the positioning apparatus may be configured as a chip connected to the central processing unit 901, with its functions being realized under control of the central processing unit 901.

Furthermore, as shown in FIG. 9, the eNB 900 may further include a transceiver 903, and an antenna 904, etc., wherein, functions of the above components are similar to those in the prior art, and shall not be described herein any further. It should be noted that the eNB 900 does not necessarily include all the parts shown in FIG. 9, and furthermore, the eNB 900 may include parts not shown in FIG. 9, and the prior art may be referred to.

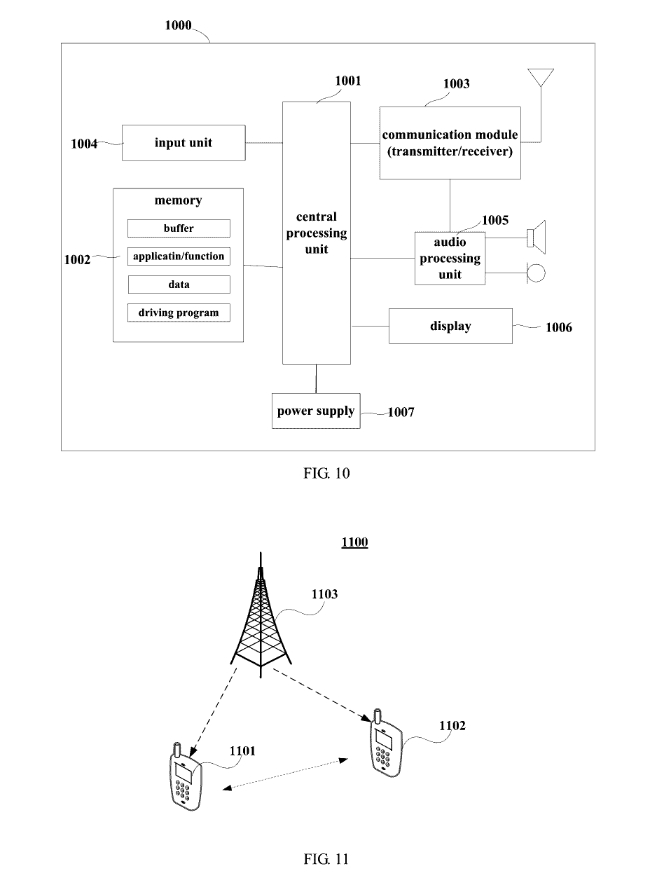

FIG. 10 is a schematic diagram of a structure of UE of the embodiment of the present disclosure. As shown in FIG. 10, the UE 1000 may include a central processing unit 1001 and a memory 1002, the memory 1002 being coupled to the central processing unit 1001. It should be noted that this figure is illustrative only, and other types of structures may also be used, so as to supplement or replace this structure and achieve telecommunications function or other functions.

In an implementation, the functions of the positioning apparatus may be integrated into the central processing unit 1001, and the central processing unit 1001 carries out the functions of the positioning apparatus as described in Embodiment 4 or 5 or 6. In this embodiment, the functions of the positioning apparatus are incorporated herein, and shall not be described herein any further.

In another implementation, the positioning apparatus and the central processing unit 1001 may be configured separately. For example, the positioning apparatus may be configured as a chip connected to the central processing unit 1001, with its functions being realized under control of the central processing unit 1001.

As shown in FIG. 10, the UE 1000 may further include a communication module 1003, an input unit 1004, an audio processing unit 1005, a display 1006 and a power supply 1007. It should be noted that the UE 1000 does not necessarily include all the parts shown in FIG. 10, and furthermore, the UE 1000 may include parts not shown in FIG. 10, and the prior art may be referred to.

As shown in FIG. 10, the central processing unit 1001 is sometimes referred to as a controller or control, and may include a microprocessor or other processor devices and/or logic devices. The central processing unit 1001 receives input and controls operations of every components of the UE 1000.

In this embodiment, the memory 1002 may be, for example, one or more of a buffer memory, a flash memory, a hard drive, a mobile medium, a volatile memory, a nonvolatile memory, or other suitable devices, which may store predefined or preconfigured information, and may further store a program executing related information. And the central processing unit 1001 may execute the program stored in the memory 1002, so as to realize information storage or processing, etc. Functions of other parts are similar to those of the prior art, which shall not be described herein any further. The parts of the UE 1000 may be realized by specific hardware, firmware, software, or any combination thereof, without departing from the scope of the present disclosure.

With the communication equipment of this embodiment, positioning services may be provided for some UEs by using some low-power nodes (including UE or eNBs) whose accurate positions are known, thereby improving positioning precision.

### Embodiment 8

An embodiment of the present disclosure further provides a communication system. FIG. 11 is a schematic diagram of topology of the communication system. As shown in FIG. 11, the communication system 1100 includes a first communication equipment 1101 and a second communication equipment 1102, and alternatively, it may further include a third communication equipment 1103.

In this embodiment, the first communication equipment 1101 may use the positioning method described in Embodiment 1, that is, carrying out the functions of the positioning apparatus described in Embodiment 4, the contents of embodiments 1 and 4 being incorporated herein, and being not going to be described herein any further.

In this embodiment, the second communication equipment 1102 may use the positioning method described in Embodiment 2, that is, carrying out the functions of the positioning apparatus described in Embodiment 5, the contents of embodiments 2 and 5 being incorporated herein, and being not going to be described herein any further.

In this embodiment, the third communication equipment 1103 may use the positioning method described in Embodiment 3, that is, carrying out the functions of the positioning apparatus described in Embodiment 6, the contents of embodiments 3 and 6 being incorporated herein, and being not going to be described herein any further.

In this embodiment, the first communication equipment 1101, the second communication equipment 1102 and the third communication equipment 1103 may be eNBs, and may also be terminals. And respective numbers of the first communication equipment 1101, the second communication equipment 1102 and the third communication equipment 1103 may be one, or two or more, depending on a network condition.

In an implementation, the first communication equipment 1101 and the second communication equipment 1102 may be parties performing D2D communication, the first communication equipment 1101 is a node whose position is known, and the number of the first communication equipment 1101 is multiple; the second communication equipment 1102 is a node to be positioned, and the third communication equipment 1103 is an eNB configuring the first communication equipment 1101 and the second communication equipment 1102 with resources used by positioning signals.

In another implementation, the first communication equipment 1101 and the second communication equipment 1102 may be parties performing D2D communication, the first communication equipment 1101 is a node to be positioned; the second communication equipment 1102 is a node whose position is known, and the number of the second communication equipment 1102 is multiple, and the third communication equipment 1103 is an eNB configuring the first communication equipment 1101 and the second communication equipment 1102 with resources used by positioning signals.

With the communication system of this embodiment, positioning services may be provided for some UEs by using some low-power nodes (including UE or eNBs) whose accurate positions are known, thereby improving positioning precision.

An embodiment of the present disclosure provides a computer readable program, which, when executed in a position apparatus or communication equipment, will cause the position apparatus or the communication equipment to carry out the positioning method as described in Embodiment 1 or 2 or 3.

An embodiment of the present disclosure provides a computer readable medium, including a computer readable program, which will cause a position apparatus or communication equipment to carry out the positioning method as described in Embodiment 1 or 2 or 3.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principles of the present disclosure, and such variants and modifications fall within the scope of the present disclosure.

What is claimed is:

1. A positioning apparatus, applicable to a first communication equipment, the apparatus comprising:
a triggering unit configured to transmit a triggering command to a second communication equipment, so as to trigger the second communication equipment to transmit a positioning signal;
wherein, the first communication equipment or the second communication equipment is a node whose position is known;
a detecting unit configured to detect and receive the positioning signal according to a configured resource used by the positioning signal; and
an estimating unit configured to estimate a distance or signal propagation time from the first communication equipment to the second communication equipment according to the positioning signal.

2. The apparatus according to claim 1, wherein the triggering command is carried via a physical device to device synchronization channel (PD2DSCH).

3. The apparatus according to claim 1, wherein the apparatus further comprises:
a first receiving unit configured to receive configuration information transmitted by the second communication equipment or a third communication equipment, the configuration information comprising a resource used by the positioning signal configured by the second communication equipment or the third communication equipment.

4. The apparatus according to claim 1, wherein the apparatus further comprises:
a first transmitting unit configured to transmit a positioning request to the second communication equipment or a third communication equipment when the first communication equipment is a node to be positioned and the second communication equipment is a node whose position is known; and
a second receiving unit configured to receive the configuration information transmitted by the second communication equipment or the third communication equipment, the configuration information comprising a resource used by the positioning signal configured by the second communication equipment or the third communication equipment.

5. The apparatus according to claim 1, wherein the apparatus further comprises:
a configuring unit configured to receive a positioning request transmitted by the second communication equipment when the first communication equipment is a node whose position being known and the second communication equipment is a node to be positioned, and configure a resource used by the positioning signal according to the positioning request; and
a second transmitting unit configured to transmit the resource used by the positioning signal configured by the configuring unit via configuration information.

6. The apparatus according to claim 5, wherein the configuration information is carried via a PD2DSCH.

7. The apparatus according to claim 1, wherein the apparatus further comprises:
a third transmitting unit configured to transmit indication information indicating a positioning capability of the first communication equipment to the second communication equipment or a third communication equipment.

8. The apparatus according to claim 1, wherein the triggering command is indication information indicating a positioning capability of the first communication equipment.

9. The apparatus according to claim 1, wherein the resource used by the positioning signal includes a bandwidth, a frequency domain position, a time domain position, a symbol length, and a sequence length, or the resource used by the positioning signal is signatures indicating a time-frequency resource index and a sequence index.

10. A positioning apparatus, applicable to a second communication equipment, the apparatus comprising:
a first receiving unit configured to receive a triggering command transmitted by a first communication equipment; and
a first transmitting unit configured to transmit a positioning signal on a configured resource used by a positioning signal according to the triggering command, so that the first communication equipment estimates a distance or signal propagation time from the first communication equipment to the second communication equipment according to the positioning signal.

11. The apparatus according to claim 10, wherein the apparatus further comprises:
a second receiving unit configured to receive configuration information transmitted by the first communication equipment or a third communication equipment, the configuration information including a resource used by the positioning signal configured by the first communication equipment or the third communication equipment.

12. The apparatus according to claim 10, wherein the apparatus further comprises:
a second transmitting unit configured to transmit a positioning request to the first communication equipment or a third communication equipment when the first communication equipment is a node whose position is known and the second communication equipment is a node to be positioned; and
a third receiving unit configured to receive configuration information transmitted by the first communication equipment or the third communication equipment, the configuration information including a resource used by the positioning signal configured by the first communication equipment or the third communication equipment.

13. The apparatus according to claim 10, wherein the apparatus further comprises:
a configuring unit configured to receive a positioning request transmitted by the first communication equipment when the first communication equipment is a node to be positioned and the second communication equipment is a node whose position is known, and configure a resource used by the positioning signal according to the positioning request; and
a third transmitting unit configured to transmit the resource used by the positioning signal configured by the configuring unit via configuration information.

14. The apparatus according to claim 10, wherein the triggering command is indication information indicating a positioning capability of the first communication equipment.

15. The apparatus according to claim 10, wherein the resource used by the positioning signal includes a bandwidth, a time domain position, a frequency domain position, a symbol length, and a sequence length, or the resource used by the positioning signal is signatures indicating a time-frequency resource index and a sequence index.

16. The apparatus according to claim 10, wherein the first transmitting unit transmits the positioning signal by following timing of a synchronization source or using timing of TA=0.

17. A positioning apparatus, comprising:
a first receiving unit configured to receive a positioning request transmitted by a first communication equipment or a second communication equipment;
a configuring unit configured to configure a resource used by a positioning signal according to the positioning request; and
a transmitting unit configured to transmit the resource used by the positioning signal via configuration information.

18. The apparatus according to claim 17, wherein the apparatus further comprises:
a second receiving unit configured to receive a distance or signal propagation time from the first communication equipment to the second communication equipment; and
a calculating unit configured to calculate a position of the first communication equipment or the second communication equipment according to the distance or the signal propagation time.

19. The apparatus according to claim 17, wherein the apparatus further comprises:
a third receiving unit configured to receive a position of the first communication equipment or the second communication equipment transmitted by the first communication equipment or the second communication equipment.

20. The apparatus according to claim 17, wherein the resource used by the positioning signal includes a bandwidth, a frequency domain position, a time domain position, a symbol length, and a sequence length, or the resource used by the positioning signal is signatures indicating a time-frequency resource index and a sequence index.
